(19) United States
(12) Patent Application Publication
(10) Pub. No.: US 2024/0400841 A1
(43) Pub. Date: Dec. 5, 2024

(54) SPECIAL EFFECT FILM PRODUCTS AND METHODS FOR MAKING THEM

(71) Applicant: SOUTHWALL TECHNOLOGIES INC., PALO ALTO, CA (US)

(72) Inventors: YUE RACHEL HU, WILBRAHAM, MA (US); KEVIN C. KROGMAN, LOS GATOS, CA (US); SPENCER ERICH HOCHSTETLER, KINGSPORT, TN (US); ALVIN A. SINGH, ROCKLIN, CA (US)

(73) Assignee: SOUTHWALL TECHNOLOGIES INC., PALO ALTO, CA (US)

(21) Appl. No.: 18/694,154

(22) PCT Filed: Oct. 18, 2022
(86) PCT No.: PCT/US2022/046976

§ 371 Date: Mar. 21, 2024

Related U.S. Application Data
(60) Provisional application No. 63/257,143, filed on Oct. 19, 2021.

(51) Int. Cl. C09D 5/36; C08J 7/04; C09D 1/00; C09D 5/00; C09D 7/40; C09D 7/62; C09D 139/00

(52) U.S. Cl. CPC C09D 5/36; C08J 7/0423; C09D 1/00; C09D 5/002; C09D 7/62; C09D 7/70; C09D 139/00; C08J 2375/04; C08J 2439/00

(57) ABSTRACT

Special effect films are disclosed that comprise a polymeric substrate and a composite coating. The composite coating is provided with a first layer comprising a polyionic binder and a second layer comprising interference particles having at least one highly refractive layer and at least one lower refractive layer, and a difference in refractive index between the highly refractive layer and the at least one lower refractive layer is at least 0.1 units.

### FIELD OF THE INVENTION

The present invention broadly relates to film products for use in automotive applications and the like, and methods for their manufacture. More particularly, the present invention relates to special effect film products or composites for coloring an article by application thereto, for example a car wrap.

### BACKGROUND OF THE INVENTION

Color has typically been imparted to optical products such as automotive and architectural window films by use of organic dyes. More particularly, the current commercial practice for producing dyed film from polyester involves swelling of the molecular structure of the substrate in baths of hot organic solvent such as ethylene glycol during the dyeing process, as swelled polyester (particularly PET) films are capable of absorbing organic dyes. These films and their manufacturing process suffer many drawbacks. Firstly, the substrates require exposure to organic solvents and elevated temperatures, which present both mechanical and chemical challenges such as environmental hazards and costs associated with storing the raw solvents and disposing of the resulting waste. Further, swelled substrates require special handling to avoid downstream stretching thereby decreasing the production yield. Next, the polyester elevated process temperatures and residual solvents in the substrate film after drying constrain downstream use and processing of substrates which in turn limits the potential end-use applications for such dyed films. On the process side, the existing methodology uses large volume dye baths which makes rapid color change within commercial manufacturing difficult. Finally, only a limited number of organic dyes are soluble and stable in the hot solvent swelling media and many of those are often subject to degradation by high energy radiation (sub 400 nm wavelength) to which the substrate is subjected when used in window film applications, thereby shortening the useful lifetime of the product.

To address these drawbacks, some film manufacturers have transitioned to using a pigmented layer on the surface of a base polymeric film for tinting a polymeric film. For example, U.S. Published Application number 2005/0019550A1 describes color-stable, pigmented optical bodies comprising a single or multiple layer core having at least one layer of an oriented thermoplastic polymer material wherein the oriented thermoplastic polymer material has dispersed within it a particulate pigment. As noted in this published application, these products can suffer a myriad of processing and performance drawbacks. For example, layers of this type are typically applied as thin films and can employ a relatively high pigment concentration to achieve a desired tint level, particularly in automotive window films with a relatively high desired level of darkening such as those with an electromagnetic energy transmittance in the visible region (or Tᵥᵢₛ) of less than 50%. These high pigment concentrations are difficult to uniformly disperse within the thin layer. More generally, pigmented layers can suffer from greater haze and reduced clarity even in applications (for example architectural window films) with a relatively moderate, low and even minimal levels of desired darkening.

Color also has previously imparted to optical products such as composites for coloring opaque articles (such as automotive panels, for example) by application thereto, as described in U.S. Pat. No. 5,030,513. Such composites are sometimes referred to in the art as paint composites or when applied to cars or automotive panels, car wraps. In order to achieve desired color saturation, however, typical thickness of the color containing layer is reported to be from about 0.1 to 3 mils (approximately 2,500 nm to 76,000 nm) at pigment concentrations of up to 80%. In addition to difficulty in achieving uniform dispersion as mentioned above, these generally thicker and high-solids pigmented coatings can suffer from surface uniformity problems known in art as orange peel or surface mottling. While surfactants, flow control agents and other similar additives may be used to minimize these issues, they are often unable to achieve the level of uniformity as required by modern day film products. Thick solvent-borne as well as water-borne coatings also require significant amount of energy to be applied to the substrate in order to dry or cure, making them less attractive from the environmental point of view.

U.S. Pat. No. 5,837,359 describes a thermoplastic multilayer resinous film with a plurality of very thin layers wherein the multilayer film contains pearlescent pigment in at least one of the interior layers. The pearlescent pigments consist of mica platelets coated with an oxide, usually titanium dioxide and/or iron oxide, and have a size of 2-15 microns.

U.S. Pat. No. 5,344,705 describes a sheet material with microspheres having a reflective layer with the layer formed of reflective flakes in a binder and wherein the flakes may be metal flakes or nacreous pigments with a thickness in the range of about 0.03 to about 0.8 microns.

U.S. Pat. Publication No. 2003/0017326 describes a color-stable, pigmented optical body comprising a single or multiple layer core having at least one layer of a thermoplastic polymer material dispersed within it a particulate pigment with a mean diameter of about 500 nm or less.

U.S. Pat. Publication No. 2020/0264348 describes an optical product that may include a reflective layer that in some embodiments may be an LbL structured dielectric reflective layer and in some embodiments may be a printed or coated reflective layer comprising particles, e.g., flakes, of reflective material as described in U.S. Pat. No. 5,344,705. See also U.S. Pat. Publication Nos. 2020/0264349, 2020/0264350 and 2020/0264351.

U.S. Pat. No. 9,891,347 relates to optical products that include a composite coating. The composite coating of the optical products includes a first layer comprising a polyionic binder and a second layer that includes an electromagnetic energy-absorbing insoluble particle. The first layer and the second layer each include a binding group component which together form a complementary binding group pair.

U.S. Pat. No. 10,338,287 describes an optical product that includes a composite pigment coating comprising a layer-by-layer coating that includes one or more pigments; each of the layers of a given bilayer may optionally include a polyionic binder, an insoluble pigment particle or both. Pigments suitable for use according to the invention are preferably particulate pigments with an average particle diameter from about 5 to about 300 nanometers, or from 10 to 50 nanometers.

U.S. Pat. No. 9,539,612 discloses a method that includes coating a substrate to provide a flame resistant substrate. In an embodiment, the method includes exposing the substrate to a cationic solution to produce a cationic layer deposited on the substrate. The cationic solution comprises cationic materials. The cationic materials comprise a polymer, a colloidal particle, a nanoparticle, a nitrogen-rich molecule, or any combinations thereof. The method further includes exposing the cationic layer to an anionic solution to produce an anionic layer deposited on the cationic layer to produce a layer comprising the anionic layer and the cationic layer. The anionic solution comprises a layerable material.

U.S. Pat. Publication No. 2021/0353505 discloses a multilayer coating film that includes a colored base layer formed directly or indirectly on a surface of a coating target, and a luster material-containing layer layered on the colored base layer and containing flaked luster materials and a colorant. The reference explains that flip-flop properties that give an effect of light and shade or metallic impression to a metallic coat provided are desirable, for example, on an automobile body. With these properties, the lightness of the coated object varies depending on an angle from which it is viewed. That is, the lightness, also described as highlights, and the darkness, also described as shades, become more distinct. The reference notes that these properties are often expressed by a flop index (FI) value of X-Rite, Inc., but that FI values obtained so far in metallic coatings is only about 18, in general, and that in their opinion, stunning, enhanced metallic impressions have not been achieved yet. It would therefore be desirable to provide a film that may provide even higher FI values.

Similarly, U.S. Pat. Publication No. 2020/0199284 discloses aqueous dispersions including multi stage-prepared polymers of olefinically unsaturated compounds and to the preparation and use thereof, in particular in the field of automobile coating. Coated substrates were subjected to measurement using an X-Rite spectrophotometer (X-Rite MA68 multi-angle spectrophotometer), and the flop indexes obtained were lower than those just described.

A continuing need exists in the art for film products that provide improved special optical effects and satisfy product longevity demands of current commercial autowrap films and vehicle coloring and protection films, while also being capable of manufacture by an environmentally friendly, aqueous-based coloring process performed preferably at ambient temperatures and pressures.

### SUMMARY OF THE INVENTION

In one aspect, the invention relates to special effect films that comprise a polymeric substrate and a composite coating. The composite coating provides a first layer comprising a polyionic binder and a second layer comprising interference particles, wherein each of the first layer and the second layer include a binding group component which together form a complementary binding group pair. The interference particles may comprise at least one highly refractive layer and at least one lower refractive layer, and a difference in refractive index between the highly refractive layer and the at least one lower refractive may be at least 0.1 units.

Further aspects of the invention are as disclosed and claimed herein.

### BRIEF DESCRIPTION OF THE DRAWINGS

The invention will be described in further detail below and with reference to the accompanying drawings, wherein like reference numerals throughout the figures denote like elements and in wherein

FIG. 1 is a schematic cross-section of an embodiment of the special effect film products of the present invention;

FIG. 2 is a schematic cross-section of an embodiment of the special effect film products of the present invention that includes a plurality of composite coatings;

FIG. 3 is a plot of visible electromagnetic transmittance (Tᵥᵢₛ) at different mica dipping times;

FIG. 4 is a plot of visible electromagnetic transmittance (Tᵥᵢₛ) at different numbers of bilayers.

### DETAILED DESCRIPTION

The present invention thus relates to special effect films and methods of making them. The special effects of the film products of the invention are the result of the use of one or more special effect particles.

Thus, in a first embodiment, special effect films are provided that comprise: a polymeric substrate; and a composite coating, the composite coating comprising a first layer comprising a polyionic binder and a second layer comprising interference particles, wherein each of the first layer and the second layer include a binding group component which together form a complementary binding group pair. According to this embodiment, the interference particles may comprise at least one highly refractive layer and at least one lower refractive layer, and a difference in refractive index between the at least one highly refractive layer and the at least one lower refractive layer is at least 0.1 units.

In a second embodiment, the difference in refractive index between the at least one highly refractive layer and the at least one lower refractive layer is at least 0.3 units.

In a third embodiment, according to any of the preceding embodiments, the difference in refractive index between the at least one highly refractive layer and the at least one lower refractive layer is at least 0.5 units.

In a fourth embodiment, according to any of the preceding embodiments, the at least one highly refractive layer is on a surface of the interference particles.

In a fifth embodiment, according to any of the preceding embodiments, the special effect film exhibits a flop index of at least 20.

In a sixth embodiment, according to any of the preceding embodiments, the special effect film exhibits a flop index of at least 25.

In a seventh embodiment, according to any of the preceding embodiments, the special effect film exhibits a flop index of at least 30.

As described herein, flop index values may be obtained by laminating the films to a black panel for flop index measurement by an X-Rite model MA68II. Alternatively, the black background could be a black coating applied to the films in any known coating method.

In an eighth embodiment, according to any of the preceding embodiments, the special effect film exhibits a flop index from about 20 to about 35.

In a ninth embodiment, according to any of the preceding embodiments, the interference particles have an average thickness via microscope from about 5 nm to about 2000 nm and an average D50 diameter via laser diffraction, reported as a volume equivalent sphere diameter, from about 1 μm to about 500 μm.

In a tenth embodiment, according to any of the preceding embodiments, the interference particles have an average thickness from 50 nm to 1000 nm (via microscope) and an average D50 diameter via laser diffraction, reported as a volume equivalent sphere diameter, from about 3 μm to about 250 μm.

In an eleventh embodiment, according to any of the preceding embodiments, the interference particles have an average thickness (via microscope) from 200 nm to 800 nm and an average D50 diameter, reported as a volume equivalent sphere diameter, from about 5 μm to about 50 μm.

As used herein, average D50 diameter values are as provided via laser diffraction, reported as a volume equivalent sphere diameter.

In a twelfth embodiment, according to any of the preceding embodiments, the interference particles reflect light at wavelengths from 300 nm to 800 nm.

In a thirteenth embodiment, according to any of the preceding embodiments, the composite coating has a total thickness of 250 nm to 5 μm.

In a fourteenth embodiment, according to any of the preceding embodiments, the composite coating has a total thickness of 500 nm to 2 μm.

In a fifteenth embodiment, according to any of the preceding embodiments, the composite coating has a total thickness of 500 nm to 1 μm.

In a sixteenth embodiment, according to any of the preceding embodiments, the first layer is immediately adjacent to the polymeric substrate at its first face and the second layer is immediately adjacent to the first layer at its opposite face.

In a seventeenth embodiment, according to any of the preceding embodiments, the special effect film further comprises a primer layer between the polymeric substrate and the composite coating.

In an eighteenth embodiment, according to any of the preceding embodiments, the second layer further comprises a pigment particle.

In a nineteenth embodiment, according to any of the preceding embodiments, the films further comprise a second composite coating, the second composite coating comprises a first layer comprising a polyionic binder and a second layer comprising a special effect particle, wherein the first layer of the second composite coating and the second layer of the second composite coating, comprise a complementary binding group pair.

In a twentieth embodiment, according to any of the preceding embodiments, the films further comprise a second composite coating, the second composite coating comprises a first layer comprising a polyionic binder and a second layer comprising a pigment particle, wherein the first layer of the second composite coating and the second layer of the second composite coating, comprise a complementary binding group pair.

In a twenty-first embodiment, according to any of the preceding embodiments, the second layer of the first composite coating and the second layer of the second composite coating in combination provide an additive effect on the special effect character and effect of the special effect film product.

In a twenty-second embodiment, according to any of the preceding embodiments, the films further comprise a mounting adhesive layer applied to a surface of the polymeric substrate opposite the composite coating.

In a twenty-third embodiment, according to any of the preceding embodiments, the films further comprise a mounting adhesive layer applied to a surface of the composite coating opposite the polymeric substrate.

In a twenty-fourth embodiment, according to any of the preceding embodiments, the films further comprise an opacifying layer applied to a surface of the composite coating opposite the polymeric substrate.

In a twenty-fifty embodiment, according to any of the preceding embodiments, the films further comprise a protective topcoat.

In a twenty-sixth embodiment, according to any of the preceding embodiments, a vehicle panel is provided having the special effect film of any of the preceding claims applied thereto.

In a twenty-seventh embodiment, according to any of the preceding embodiments, a vehicle is provided having the special effect film of any of the preceding claims.

In a twenty-eighth embodiment, according to any of the preceding embodiments, the vehicle is selected from the group consisting of an automobile, aircraft or boat.

In a twenty-ninth embodiment, according to any of the preceding embodiments, at least one of the first layer and the second layer of the composite coating is formed from an aqueous solution.

In a thirtieth embodiment, according to any of the preceding embodiments, the polymeric substrate comprises one or more of a polyethylene terephthalate (PET) film, a polyvinyl butyral film, a polyurethane film, a poly(vinyl chloride) film, or a multilayer polymeric film.

In a thirty-first embodiment, according to any of the preceding embodiments, the polymeric substrate comprises a flexible multilayer polymeric composite film.

In a thirty-second embodiment, according to any of the preceding embodiments, the flexible multilayer polymeric composite film is a polyurethane-based flexible multilayer composite film.

In a thirty-third embodiment, according to any of the preceding embodiments, the polymeric substrate is a polyvinyl butyral film.

In a thirty-fourth embodiment, according to any of the preceding embodiments, the special effect film is a composite for coloring an opaque article by application thereto.

In one aspect, then, the invention relates to special effect films that provide a desirable “flip-flop” effect, as indicated by a suitable flop index value. Another method that can be used to detect the desired effect is image analysis. This effect appears to be, at least in part, a function of the particles' orientation and the degree to which they are all aligned in the same direction, which is generally difficult to achieve via wet coating. In the composite coatings of the special effect films of the invention, individuals or stacks of interference particles are dispersed in bulk polymer. Although significant research has been conducted to achieve better pigment alignment in a coating, many the developed methods, e.g. powder coating, are designed to be used on hard/rigid surfaces. We have surprisingly found that the composite coatings described herein may be used to provide special effect films with unusually high flop index values, among other features

The interference particles of the invention, in one aspect, have an average thickness from about 5 nm to about 2000 nm and an average diameter from about 1 μm to about 500 μm. In another aspect, the interference particles have an average thickness from 50 nm to 1000 nm and an average diameter from about 3 μm to about 250 μm. In yet another aspect, the interference particles have an average thickness from 200 nm to 800 nm and an average diameter from about 5 μm to about 50 μm, or as described elsewhere herein.

In one aspect, the interference particles have at least a first layer and a second layer, and the layers of the interference particles of the invention have different refractive indices, and may thus reflect a color resulting from the constructive or destructive interference of reflections of light from the different layers. The interference particles may thus comprise at least one highly refractive layer and at least one lower refractive layer, and a difference in refractive index between the at least one highly refractive layer and the at least one lower refractive layer may be at least 0.1 units.

The special effect particles useful according to the invention are thus interference particles, such as those disclosed in U.S. Pat. Publication No. 2007/065381, the relevant disclosure of which is incorporated herein by reference. These interference particles are typically thin, plate-like particles, comprising two or more layers of controlled thickness. The layers of the interference particles of the invention have different refractive indices and may thus reflect a color resulting from the constructive or destructive interference of reflections of light from the different layers. In one aspect, the color may be determined by selecting an appropriate thickness of the layers. Thus, in contrast to colored pigments, interference particles may themselves be colorless, and yet reflect a desired color.

In this aspect, then, the interference particles comprise at least a first layer and a second layer, having different refractive indices. These may be described as at least one highly refractive layer and at least one lower refractive layer. In one aspect, then, a first layer of the particle may have a lower refractive index than a second layer, or a second layer have a higher refractive index than a first layer. In another aspect, a difference in refractive index between the at least one highly refractive layer and the at least one lower refractive layer is at least about 0.1, or at least 0.2, or at least 0.3, or at least 0.5, or at least 1.0. In another aspect, a difference in refractive index between the at least one highly refractive layer and the at least one lower refractive layer may be from about 0.1 to about 2, or from 0.3 to 1.8, or from 0.5 to 1.5.

In another aspect, the layer with higher refractive index may have a refractive index greater than 1.8, or greater than 2.0, or as described elsewhere herein. In one aspect, these highly reflective layers may comprise metal oxides, metal hydroxides, and/or hydrated metal oxides which are selected from the group consisting of various stoichiometric ratios such as TiO₂, Fe₂O₃, Fe₃O₄, TiFe₂O₅, Fe₂Ti₃O₉, FeTiO₃, ZnO, SnO₂, CoO₃, Co₃O₄, ZrO₂, Cr₂O₃, VO₂, V₂O₃, (SnSb)O₂, and mixtures thereof, or as described elsewhere herein.

As noted, the reflected color is in part a function of the relative thicknesses. For example, the colors of certain titanium dioxide-coated micas change from white to yellow, to red, to blue and then green when the titanium dioxide layer thickness increases from 40 nm to 160 nm. See, for example, Sun Chemical technical report—Pearlescent Pigments in Coatings—A Primer.

Non-limiting examples of suitable interference particles useful according to the present invention may comprise a lower refractive layer comprised of natural or synthetic mica, borosilicate glass, silica, alumina, and mixtures thereof, provided with higher refractive layers comprised, for example, of films of high refractive index material such as just described, wherein the thickness of the higher refractive layer may be, for example, from about 25 nm to about 500 nm, or from 35 nm to 350 nm, or from 40 nm to 200 nm.

Useful interference pigments are available commercially from a variety of suppliers, for example, Sun Chemical, Eckart, BASF, etc.

The interference particles useful in the composite coatings of the invention may be provided with a surface treatment to incorporate a binding group component that can be used in the deposition process. As noted, the binding group component of the first layer and the binding group component of the second layer constitute a complementary binding group pair. As used herein, the phrase “complementary binding group pair” means that binding interactions, such as electrostatic binding, hydrogen bonding, Van der Waals interactions, hydrophobic interactions, and/or chemically-induced covalent bonds are present between the binding group component of the first layer and the binding group component of the second layer of the composite coating.

Other useful interference particles according to the invention are those disclosed in U.S. Pat. Publication No. 2018/0133116, the relevant portion of which is incorporated herein by reference. Thus, interference particles useful according to the invention include those having an average particle diameter of the interference particle of from about 500 nm to about 750 μm, or from 1 μm to 200 μm, or from 1 μm to 100 μm, or as described elsewhere herein. The interference particles may comprise, for example, a flaky inorganic substrate; a transparent metal layer that coats the inorganic substrate; and/or a metal oxide layer that coats the metal layer or the inorganic substrate. Interference particles may, in some cases, exhibit brittle behavior and may have poor mechanical properties. Many materials may be mentioned, for example, mica, alumina, silica and metal flakes, especially titania, silica and metal oxides, and iron and chromium oxides.

Interference particles useful according to the invention may thus have an average particle diameter of the interference pigment, that is an average D50 diameter via laser diffraction, reported as a volume equivalent sphere diameter of the present invention, from, for example, about 1 μm to about 500 μm, or at least 3 μm, or at least 5 μm, or at least 10 μm, or at least 40 μm. Further, the average particle diameter of the interference pigment may be up to about 750 μm, or up to 500 μm, or up to 400 μm, or up to 300 μm, or up to 250 μm, or up to 200 μm, or up to 100 μm, or up to 90 μm, or up to 50 μm. The average particle diameter of the interference pigment can be measured with a laser diffraction particle size analyzer, reported as a volume equivalent sphere diameter.

In a further aspect, the average thickness of the interference particles of the present invention may be, for example, from about 1 nm to about 2000 nm, or from about 5 nm to about 1500 nm, or at least 5 nm, or at least 10 nm, or at least 15 nm, or at least 25 nm, or at least 50 nm, or at least 75 nm. Further, the average thickness of the interference particle may be 2000 nm or less, or 1500 nm or less, or 1000 nm or less, or 750 nm or less, or 500 nm or less, or 300 nm or less.

We note that significantly longer deposition or dipping time is needed if the particle diameter becomes too large, whereas the interference effect is reduced if the particle diameter is too small. The average particle diameter of the interference pigment may thus be from 5 μm to 100 μm, or from 10 to 30 μm, or as described elsewhere herein. Diameter is understood to refer to a particle diameter corresponding to 50% of cumulative volume percentage in a particle distribution measured with a laser diffraction particle size analyzer, reported as a volume equivalent sphere diameter.

The average thickness of the interference pigment of the present invention may be, for example, from about 5 nm to about 2000 nm, or as described elsewhere herein the thickness being understood to be the dimension between two surfaces of an object, usually the dimension of smallest measure, and as measured by a microscope.

Significantly longer deposition time is needed if the thickness becomes too large, whereas the interference effect is diminished if the thickness is too small. In one aspect, then, the average thickness of the interference pigment may be, for example, from about 10 nm to about 2000 nm, or from 100 nm to 1000 nm, or from 200 nm to 800 nm, or as described elsewhere herein.

The special effect films of the present invention thus comprise special effect particles in which layer-by-layer assembly processes may be used on flexible substrates to form composite coatings. The special effect films exhibit markedly improved pigment platelet alignment compared to other wet coating techniques, as evidenced by flop index values.

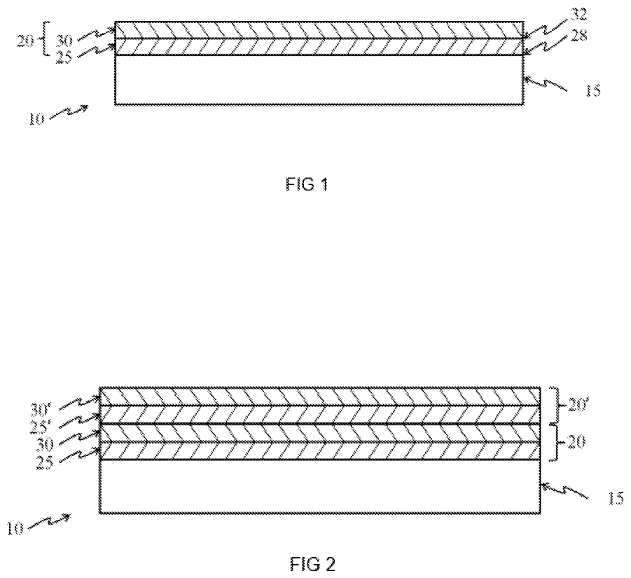

As shown in FIGS. 1 and 2, the present invention is thus generally directed to a special effect film 10 comprising a polymeric substrate 15 and a composite coating 20. The composite coating 20 includes a first layer 25 and a second layer 30. Preferably first layer 25 is immediately adjacent to said polymeric substrate 20 at its first face 28 and second layer 30 is immediately adjacent to first layer 25 at its opposite face 32. Alternatively, a primer layer may be provided on the polymeric substrate prior to deposition of the composite coating. This first layer 25 typically includes a polyionic binder while the second layer 30 typically includes a special effect particle. Each layer 25 and 30 includes a binding group component with the binding group component of the first layer and the binding group component of the second layer constituting a complementary binding group pair. As used herein, the phrase “complementary binding group pair” means that binding interactions, such as electrostatic binding, hydrogen bonding, Van der Waals interactions, hydrophobic interactions, and/or chemically induced covalent bonds are present between the binding group component of the first layer and the binding group component of the second layer of the composite coating. A “binding group component” is a chemical functionality that, in concert with a complementary binding group component, establishes one or more of the binding interactions described above. The components are complementary in the sense that binding interactions are created through their respective charges.

The first layer 25 of the composite coating typically includes a polyionic binder, which is defined as a macromolecule containing a plurality of either positive or negative charged moieties along the polymer backbone. Polyionic binders with positive charges are known as polycationic binders while those with negative charges are termed polyanionic binders. Also, it will be understood by one of ordinary skill that some polyionic binders can function as either a polycationic binder or a polyanionic binder depending on factors such as pH and are known as amphoteric. The charged moieties of the polyionic binder constitute the “binding group component” of the first layer.

Suitable polycationic binder examples include poly(allylamine hydrochloride), linear or branched d poly(ethyleneimine), poly(diallyl dimethylammonium chloride), macromolecules termed polyquaterniums or polyquats and various copolymers thereof. Blends of polycationic binders are also contemplated by the present invention. Suitable polyanionic binder examples include carboxylic acid containing compounds such as poly(acrylic acid) and poly(methacrylic acid), as well as sulfonate containing compounds such as poly(styrene sulfonate) and various copolymers thereof. Blends of polyanionic binders are also contemplated by the present invention. Polyionic binders of both polycationic and polyanionic types are generally well known to those of ordinary skill in the art and are described for example in U.S. Published Patent Application number US20140079884 to Krogman et al. Examples of suitable polyanionic binders include polyacrylic acid (PAA), poly(styrene sulfonate) (PSS), poly(vinyl alcohol) or poly(vinylacetate) (PVA, PVAc), poly(vinyl sulfonic acid), carboxymethyl cellulose (CMC), polysilicic acid, poly(3,4-ethylenedioxythiophene) (PEDOT) and combinations thereof with other polymers (e.g. PEDOT:PSS), polysaccharides and copolymers of the above mentioned. Other examples of suitable polyanionic binders include trimethoxysilane functionalized PAA or PAH or biological molecules such as DNA, RNA or proteins. Examples of suitable polycationic binders include poly(diallyl dimethylammonium chloride) (PDAC), Chitosan, poly(allyl amine hydrochloride) (PAH), polysaccharides, proteins, linear poly(ethyleneimine) (LPEI), branched poly(ethyleneimine) BPEI and copolymers of the above-mentioned, and the like. Examples of polyionic binders that can function as either polyanionic binders or polycationic binders include amphoteric polymers such as proteins and copolymers of the above mentioned polycationic and polyanionic binders.

The concentration of the polyionic binder in the first layer may be selected based in part on the molecular weight of its charged repeat unit but will typically be between 0.1 mM-100 mM, more preferably between 0.5 mM and 50 mM and most preferably between 1 and 20 mM based on the molecular weight of the charged repeat unit comprising the first layer. Preferably the polyionic binder is a polycationic binder and more preferably the polycationic binder is polyallylamine hydrochloride. Most preferably the polyionic binder is soluble in water and the composition used to form the first layer is an aqueous solution of polyionic binder. In an embodiment wherein the polyionic binder is a polycation and the first layer is formed from an aqueous solution, the pH of the aqueous solution is selected so that from 5 to 95%, preferably 25 to 75% and more preferably approximately half of the ionizable groups are protonated. Other optional ingredients in the first layer include biocides or shelf-life stabilizers.

The second layer 30 of the composite coating 20 typically includes the special effect particle. The term “special effect particle” means that the particle is purposefully selected as a component for the optical product for its effect on visible light reflected from it. These particles are typically insoluble, the term “insoluble” referring to the fact that the particle does not substantially dissolve in the composition used to form the second layer 30 and exists as a particle in the optical product structure. The special effect particle is preferably a visible electromagnetic energy absorber and reflector. As noted, the special effect particle may be, for example, an interference particle, or a metallic flake particle.

The composites of the invention may optionally further comprise electromagnetic energy-absorbing insoluble particles, as disclosed and claimed in U.S. Pat. No. 9,891,347, the relevant disclosure of which is incorporated herein by reference. These electromagnetic energy-absorbing insoluble particles may appear in a separate layer from the second layer containing the special effect particle, for example when it is desired that the special effect films of the invention be colored by an electromagnetic energy-absorbing insoluble particle pigment, or may be combined with the special effect particles in the same layer. In this aspect then, the particles used, whether interference particles, metal flakes, and/or electromagnetic energy-absorbing insoluble particles, may be present in the second layer in an amount, for example, of from 30% to 60% by weight based on the total weight of the second layer. In order to achieve the desired effect, the second layer may be formed from a composition that includes the insoluble electromagnetic energy-absorbing particles, wherein the amount of all particles may be, for example, from about 0.25 to about 2 weight percent based on the total weight of the composition.

The phrase “electromagnetic energy-absorbing” means that the optional particles are purposefully selected as a component for the optical film products for their preferential absorption at particular spectral wavelength(s) or wavelength ranges(s), making them especially useful as colorants or pigments. The term “insoluble” is meant to reflect the fact that the particle does not substantially dissolve in the composition used to form the second layer 30 and exists as a particle in the optical product structure. The electromagnetic energy-absorbing insoluble particle is preferably a visible electromagnetic energy absorber, such as a pigment; however, insoluble particles such as UV absorbers or IR absorbers, or absorbers in various parts of the electromagnetic spectrum that do not necessarily exhibit color are also within the scope of the term.

Pigments suitable for use as the optional electromagnetic energy-absorbing insoluble particles of the second layer are preferably particulate pigments with an average particle diameter of between 5 and 300 nanometers, more preferably between 10 and 50 nanometers, often referred to in the art as nanoparticle pigments. Even more preferably, the surface of the pigment includes the binding group component of the second layer. Suitable pigments are available commercially as colloidally stable water dispersions from manufacturers such as Cabot, Clariant, DuPont, Dainippon and DeGussa. Particularly suitable pigments include those available from Cabot Corporation under the Cab-O-Jet® name, for example 250C (cyan), 265M (magenta), 270Y (yellow) or 352K (black). In order to be stable in water as a colloidal dispersion, the pigment particle surface is typically treated to impart ionizable character thereto and thereby provide the pigment with the desired binding group component on its surface. It will be understood by ordinary skill that commercially available pigments are sold in various forms such as suspensions, dispersions and the like, and care should be taken to evaluate the commercial form of the pigment and modify it as/if necessary to ensure its compatibility and performance with the optical product components, particularly in the embodiment wherein the pigment surface also functions as the binding group component of the second layer.

Multiple pigments may be utilized in the second layer to achieve a specific hue or shade or color in the final product; however, it will again be understood by ordinary skill that, should multiple pigments be used, they should be carefully selected to ensure their compatibility and performance both with each other and with the other special effect film product components such as the special effect particles. This is particularly relevant in the embodiment wherein the pigment surface also functions as a binding group component of the second layer, as for example particulate pigments can exhibit different surface charge densities due to different chemical modifications that can impact compatibility.

Optionally the second layer of the composite coating further includes a screening agent. A “screening agent” is defined as an additive that promotes even and reproducible deposition of the second layer via improved dispersion of the particles within the second layer by increasing ionic strength and reducing interparticle electrostatic repulsion. Screening agents are generally well known to those of ordinary skill in the art and are described for example in U.S. Published Patent Application number US20140079884 to Krogman et al. Examples of suitable screening agents include any low molecular weight salts such as halide salts, sulfate salts, nitrate salts, phosphate salts, fluorophosphate salts, and the like. Examples of halide salts include chloride salts such as LiCl, NaCl, KCl, CaCl₂), MgCl₂, NH₄Cl and the like, bromide salts such as LiBr, NaBr, KBr, CaBr₂, MgBr₂, and the like, iodide salts such as LiI, NaI, KI, CaI₂, MgI₂, and the like, and fluoride salts such as, NaF, KF, and the like. Examples of sulfate salts include Li₂SO₄, Na₂SO₄, K₂SO₄, (NH₄)₂SO₄, MgSO₄, CoSO₄, CuSO₄, ZnSO₄, SrSO₄, Al₂(SO₄)₃, and Fez (SO₄)₃. Organic salts such as (CH₃)₃CCl, (C₂H₅)₃CCl, choline chloride and the like are also suitable screening agents. In one embodiment, non-coordinating choline chloride is chosen as a preferred screening agent. The presence and concentration level of a screening agent may allow for higher loadings of the particles such as those that may be desired in optical products with a Tᵥᵢₛ of no more than 50% and also may allow for customizable and carefully controllable loadings of the particles to achieve customizable and carefully controllable film product Tᵥᵢₛ levels.

Suitable screening agent concentrations can vary with salt identity and are also described for example in U.S. Published Patent Application number US2014/0079884 to Krogman et al. In some embodiments, the screening agent concentration can range between 1 mM and 1000 mM or between 10 mM and 100 mM or between 30 mM and 80 mM. In some embodiments the screening agent concentration is greater than 1 mM, 10 mM, 100 mM or 500 mM.

The second layer of the composite coating may also contain other ingredients such as biocides or shelf-life stabilizers.

In some embodiments, the special effect films of the present invention may include a plurality of composite coatings. For example, as depicted in FIG. 2, the optical product 10 includes first and second composite coatings 20 and 20′, each with a first layer and second layer, i.e. first composite coating 20 including first layer 25 and second layer 30 and second composite coating 20′ including first layer 25′ and second layer 30′. This depiction is not intended to be limiting in any way on the possible number of composite coatings and one of ordinary skill will appreciate that this depiction is simply exemplary and illustrative of an embodiment with multiple or a plurality of composite coatings. The examples below further illustrate embodiments with a plurality of composite coatings.

For embodiments with a plurality of composite coatings, it will be appreciated that the particles for the second layer in each composite coating may be independently selected and that the second layers will in combination provide an additive effect on the special effect, and/or electromagnetic energy-absorbing character and effect, of the special effect films of the invention. For the embodiment shown in FIG. 2, this means that the second layer 30 of the first composite coating 20 and the second layer 30′ of the second composite coating 20′ in combination provide an additive effect on the character and effect of the special effect film product.

This additive effect can be customized and carefully controlled in part by the nature and concentration of the particles in each second layer as dispersed through the presence of the screening agent. For example, in an embodiment wherein an electromagnetic energy-absorbing particle is present and is a pigment, the second layers will in combination provide an additive effect on the visually perceived color of the film product. In this embodiment, the particles for each second layer may be of same or similar composition and/or color such that the additive effect is to increase intensity or depth or darkness of the visually perceived color of the optical product or, stated another way, to reduce electromagnetic transmittance in the visible wavelength range (or Tᵥᵢₛ). In another embodiment, carbon black may be used as a pigment for at least one second layer and pigments such as those listed above are used as pigments for other second layer(s) such that the additive effect is a visually perceived darkened color, also reducing electromagnetic transmittance in the visible wavelength range (or Tᵥᵢₛ).

As discussed above, the present invention may be useful in products wherein relatively high levels of darkening or special effects are desired. Accordingly, in a particularly preferred embodiment, the film products of the present invention have a Tᵥᵢₛ of no more than 50%. In yet another embodiment, the pigments for each second layer may be of complementary composition and/or color such that the additive effect is a visually perceived color different from and formed by their combination of the individual pigments, for example an additive perceived “green” color achieved by utilizing a blue pigment for one second layer and a yellow pigment for another second layer.

The polymeric substrate 15 may in the broadest sense be any substrate known in the art as useable as a film product component. A suitable polymeric substrate is typically a flexible polymeric film, more particularly a polyethylene terephthalate (PET) film of a thickness of between 12 μm and 375 μm or a polyvinyl butyral (PVB) film, preferably of a thickness of between 0.01 to 1 mm and more preferably a thickness of 15 to 30 mils (0.38 to 0.76 mm). As prior art optical products for window film applications and employing dyes exhibit a variety of drawbacks, the polymeric substrate is most preferably an undyed transparent polyethylene terephthalate film. The polymeric substrate may also be a flexible polyurethane or flexible poly(vinyl chloride) film or may be a flexible multilayer polymeric composite film such as a polyurethane-based multilayer composite film as described for example in U.S. Pat. No. 8,765,263, the disclosure of which is incorporated herein by reference. The substrate may alternatively comprise a polyvinyl acetal such as PVB.

The polymeric substrate may further include additives known in the art to impart desirable characteristics. A particular example of such an additive is an ultraviolet (UV) absorbing material such as benzotriazoles, hydroxybenzophenones or triazines. A useful polymeric substrate with a UV absorbing additive incorporated therein is described in U.S. Pat. No. 6,221,112, originally assigned to a predecessor assignee of the present invention.

In one embodiment wherein the polymeric substrate is a flexible polymeric film such as PET or TPU, the film product may be a window film or autowrap film. In one embodiment, the special effect films of the present invention may have a visible light transmittance or Tᵥᵢₛ of no more than 50%, or no more than 45%, or no more than 40%.

The films may optionally include layers or coatings known to those of ordinary skill in the window film art. Coatings for example may include protective hardcoats, scratch-resist or “SR” coats, adhesive layers, protective release liners and the like. Layers may include for example metallic layers applied by sputtering or other known techniques. Such layers or coatings may be components of the polymeric substrate. Further, the polymeric substrate may be a laminated or multilayer structure.

In one embodiment, the special effect film product may be an interlayer for laminated glass. In this embodiment, the polymeric substrate may be formed from film-forming materials known in the art for this purpose, including for example plasticized polyvinyl butyral (PVB), polyurethanes, polyvinyl chloride, polyvinyl acetal, polyethylene, ethyl vinyl acetates and the like. A preferred film-forming material for the interlayer is a plasticized PVB such as that used in a commercially available from Eastman Chemical Company as SAFLEX® PVB interlayer. In this embodiment, the composite coating may be formed on at least one surface of the polymeric substrate.

In an embodiment wherein the polymeric substrate is a flexible polymeric film such as PET, the film product may be a composite interlayer for laminated glass including at least one safety film or interlayer. The safety film may be formed from film-forming materials known in the art for this purpose, including for example plasticized polyvinyl butyral (PVB), polyurethanes, polyvinyl chloride, polyvinyl acetal, polyethylene, ethyl vinyl acetates and the like. Preferred safety film is a plasticized PVB film or interlayer commercially available from Eastman Chemical Company as SAFLEX® PVB interlayer. Preferably, the composite interlayer includes two safety films or one film layer and one coating layer, such as a PVB coating that encapsulate the polymeric substrate. Composite interlayers of this general type are known in the art and are described for example in U.S. Pat. Nos. 4,973,511 and 5,091,258, the contents of which are incorporated herein by reference.

In another embodiment, the special effect film product of the present invention is a composite for coloring or otherwise altering the appearance of an article such as an automobile by application thereto. Such composites are known in the art and are sometimes referred to in the art as a colorant composite, paint composite, or car wrap. More particularly, the article may be a vehicle selected from the group consisting of an automobile, aircraft or boat; a vehicle panel or part such as a bumper, hood, fender or door; and a portion thereof. In this embodiment, the composite is applied to or adhered to the article using techniques described in the above-referenced '263 patent or in U.S. Pat. No. 5,030,513, the disclosure of which is also incorporated herein by reference. One of ordinary skill will appreciate that the term “coloring” means for example imparting a color, multiple colors, or an aesthetic color-based design or pattern to the opaque article.

In another aspect, the present invention is directed to a method for forming a special effect film product. The method of the present invention includes (a) applying a first coating composition to a polymeric substrate to form a first layer and (b) applying a second coating composition atop said first layer to form a second layer, said first layer and said second layer together constituting a composite coating. The first coating composition includes a polyionic binder and the second coating composition includes at least one special effect particle and each of said first and second coating compositions include a binding group component which together form a complementary binding group pair. The second coating composition preferably includes a screening agent as defined above.

In a preferred embodiment, at least one of the first and second coating compositions are an aqueous dispersion or solution and most preferably both of the first and second coating compositions are an aqueous dispersion or solution. In this embodiment, both applying steps (a) and (b) are performed at ambient temperature and pressure.

The optical products of the present invention may be manufactured using known “layer-by-layer” (LbL) processes such as described in Langmuir, 2007, 23, 3137-3141 or in U.S. Pat. Nos. 8,234,998 and 8,689,726 and U.S, Published Application US 2014/0079884, co-invented by co-inventor Krogman of the present application, the disclosures of which are incorporated herein by reference.

As disclosed in U.S. Pat. Publication No. 2015/243928A1, the processes of contacting the substrates with the various solutions used may include, without limitation, dip coating, spin coating, spray coating, roll coating, or printing. Any suitable solvent may be used in the process, but water may be preferred. The exposure/deposition steps in the anionic and cationic solutions may occur at any suitable temperature and pressure, although room temperature and atmospheric pressure may be preferred.

The composites of the invention can be subjected to additional treatments that further enhance the advantageous properties of these structures. Representative treatments include chemical crosslinking. Intermediate layers formed during the preparation process can be subject to additional treatment (e.g. crosslinking) to enhance the properties of the product coated structure, that is, post-deposition cross-linking.

Alternatively, primer polymer bilayers consisting of polycation and polyanion can be inserted to the beginning of the stack or the middle of the stack to increase the deposition density of the special effect pigments. Such primers may have any number of layers. The layer of primer proximate the substrate has an interaction with an attraction to the substrate. The layer of primer proximate to the first composite layer has an interaction with an attraction to the first composite layer. In one embodiment, primer layer is a single layer or a bilayer having a first primer layer and a second primer layer. The first primer layer may be a cationic layer comprising a first primer layer material, and the second primer layer may be an anionic layer comprising the second primer layer materials. Examples of such first primer layer materials include poly(allylamine hydrochloride), linear or branched poly(ethyleneimine), poly(diallyl dimethylammonium chloride), macromolecules termed polyquaterniums or polyquats and various copolymers thereof. Examples of such second primer layer materials include carboxylic acid containing compounds such as poly(acrylic acid) and poly(methacrylic acid), as well as sulfonate containing compounds such as poly(styrene sulfonate) and various copolymers thereof. In an embodiment, first primer layer materials comprise PAH while second primer layer materials comprise polyacrylic acid. In other embodiments, primer layer has multiple layers.

Alternatively, colorant can be introduced to the coated structure by various ways, in addition to those already described, such as by a pigment colorant and the special effect particles being added to the same dispersion and deposited in the same layer or in different layers, or colorant added by another coating method in a separate layer.

The following examples, while provided to illustrate with specificity and detail the many aspects and advantages of the present invention, are not be interpreted as in any way limiting its scope. Variations, modifications, and adaptations which do not depart from the spirit of the present invention will be readily appreciated by one of ordinary skill in the art.

### Example 1

To produce a coating composition suitable for forming the first layer (binding layer) of the composite coating, 7 g of a relatively high molecular weight polyallylamine hydrochloride stock solution (Nittobo PAA-HCl-10L, MW 150K) was diluted with 2 L of deionized water. The pH of the resulting solution was adjusted to 9.5 with 3M sodium hydroxide solution. To produce a coating composition suitable for forming the second layer of the composite coating, 30 g of mica flakes Sun Chemical Sunmica Gold (Product Code 2841117), which is reported to be 46-56% mica (RI of about 1.5) coated with 22-27% titanium dioxide (RI of about 2.6) and 22-27% iron oxide (RI of about 2.9), with a reported average particle size range D50 via laser diffraction, reported as a volume equivalent sphere diameter, of 12 microns, and a thickness of 650 nm (via microscope) were mixed with 1 L of deionized water. The resulting suspension was gently agitated via a magnetic stir bar. A 6 mil thick, 2″×2″ sheet of thermoplastic polyurethane (TPU) film with one side covered by a 2 mil PET liner was used as substrate.

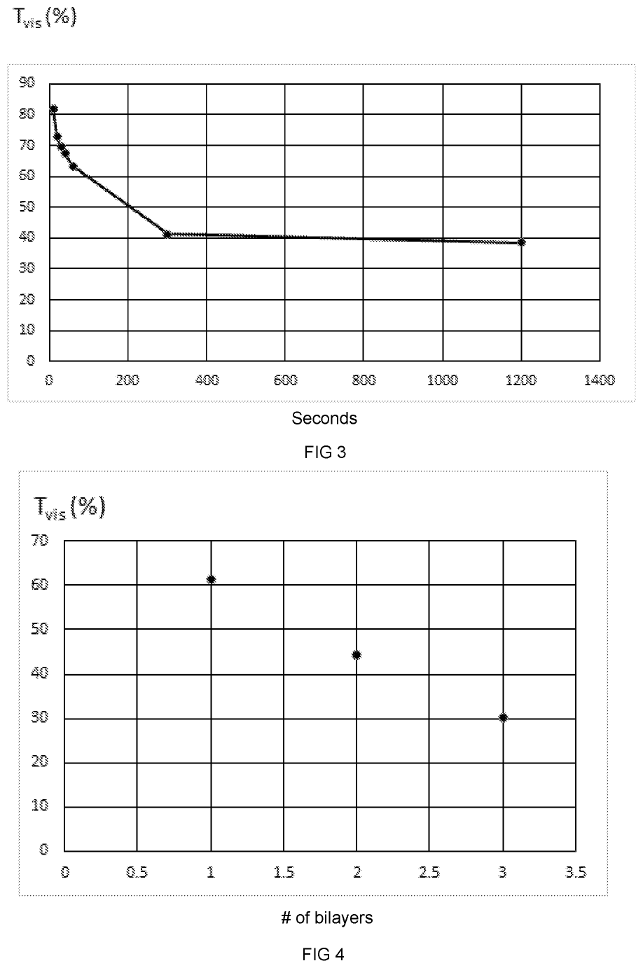

A first layer was formed on the TPU sheet by dip coating for 120 seconds, at ambient pressure and temperature, with the first coating composition containing Nittobo PAA-HCl-10 L (MW 150K). Excess non-absorbed material was rinsed away by dipping into deionized water. The TPU sheet was then dipped into the second coating composition containing the Sun Chemical Sunmica Gold interference pigment for various durations of time (10 seconds to 1200 seconds) with excess material again rinsed away in a similar fashion as the first layer. Once the film is air-dry, the PET liner was removed and the visible electromagnetic transmittance (Tᵥᵢₛ) of the resulting coated film was measured by a BYK HazeGard Pro. The results were summarized in Table 1 and FIG. 3. The films were then laminated to a black panel for flop index measurement by an X-Rite model MA68II. The results were also summarized in Table 1.

TABLE 1
Visible electromagnetic transmittance (Tᵥᵢₛ) at
different mica dipping times (single bilayer)

| Dipping time (sec) | 10 | 20 | 30 | 40 | 60 | 300 | 1200 |
|---|---|---|---|---|---|---|---|
| Tᵥᵢₛ (%) | 81.9 | 72.9 | 69.5 | 67.4 | 63.4 | 41.4 | 38.5 |
| Flop Index | 31.6 | 29.6 | 27.6 | 24.4 | 25.2 | 29.5 | 24.7 |

### Example 2. Tvis Vs # of Bilayers

To produce a coating composition suitable for forming the first layer (binding layer) of the composite coating, 7 g of polyallylamine hydrochloride stock solution (Nittobo PAA-HCl-10 L, MW 150K as above) was diluted with 2 L of deionized water. The pH of the resulting solution was adjusted to 9.5 with 3M sodium hydroxide solution. To produce a coating composition suitable for forming the second layer of the composite coating, 30 g of the mica flakes Sun Chemical Sunmica Gold used above were mixed with 1 L of deionized water. The resulting suspension was gently agitated via a magnetic stir bar. A 6 mil thick, 2″×2″ sheet of thermoplastic polyurethane (TPU) film with one side covered by a 2 mil PET liner was used as substrate.

A first layer was formed on the TPU sheet by dip coating for 120 seconds, at ambient pressure and temperature, with the first coating composition containing Nittobo PAA-HCl-10 L (MW 150K). Excess non-absorbed material was rinsed away by dipping into deionized water. The TPU sheet was then dipped into the second coating composition containing Sun Chemical Sunmica Gold for 120 seconds with excess material again rinsed away in a similar fashion with the first layer. This deposition process was repeated for various times (0-2 times). Once the film was air-dry, the PET liner was removed and the visible electromagnetic transmittance (Tvis) of the resulting coated film was measured by a BYK HazeGard Pro. The results were summarized in Table 2 and FIG. 4. The films were then laminated to a black panel for flop index measurement by an X-Rite model MA68II. The results were also summarized in Table 2.

TABLE 2
Visible electromagnetic transmittance
(Tvis) at different number of bilayers

| Number of bilayers | 1 | 2 | 3 |
|---|---|---|---|
| Tᵥᵢₛ (%) | 61.3 | 44.3 | 30.2 |
| Flop Index | 27.4 | 25.8 | 24.4 |

### Example 3. Tvis Vs MW of PAH

To produce a coating composition suitable for forming the first layer (binding layer) of the composite coating, 7 g of a relatively low molecular weight polyallylamine hydrochloride stock solution (Nittobo PAA-HCl-05, MW 5K) was diluted with 2 L of deionized water. The pH of the resulting solution was adjusted to 9.5 with 3M sodium hydroxide solution. To produce a coating composition suitable for forming the second layer of the composite coating, 30 g of the mica flakes Sun Chemical Sunmica Gold used above were mixed with 1 L of deionized water. The resulting suspension was gently agitated via a magnetic stir bar. A 6 mil thick, 2″×2″ sheet of thermoplastic polyurethane (TPU) film with one side covered by a 2 mil PET liner was used as substrate.

A first layer was formed on the TPU sheet by dip coating for 120 seconds, at ambient pressure and temperature, with the first coating composition containing Nittobo PAA-HCl-05 (MW 5K). Excess non-absorbed material was rinsed away by dipping into deionized water. The TPU sheet was then dipped into the second coating composition containing Sun Chemical Sunmica Gold for 300 seconds with excess material again rinsed away in a similar fashion with the first layer. Once the film was air-dry, the PET liner was removed and the visible electromagnetic transmittance (Tvis) of the resulting coated film was measured by a BYK HazeGard Pro. The Tvis was 63.4%. As a comparison, the Tvis from a film coated with 150K polyallylamine hydrochloride under otherwise the same condition (Example 1) was 41.4%. The flop index of the resulting film was found to be 25.5 as measured by an X-Rite model MA68II.

### Example 4. Tvis Vs pH of PAH

To produce a coating composition suitable for forming the first layer (binding layer) of the composite coating, 7 g of the relatively high molecular weight polyallylamine hydrochloride stock solution (Nittobo PAA-HCl-10 L, MW 150K) was diluted with 2 L of deionized water. The pH of the resulting solution was adjusted to 7.5 with 3M sodium hydroxide solution. To produce a coating composition suitable for forming the second layer of the composite coating, 30 g of mica flakes Sun Chemical Sunmica Gold used above were mixed with 1 L of deionized water. The resulting suspension was gently agitated via a magnetic stir bar. A 6 mil thick, 2″×2″ sheet of thermoplastic polyurethane (TPU) film with one side covered by a 2 mil PET liner was used as substrate.

A first layer was formed on the TPU sheet by dip coating for 120 seconds, at ambient pressure and temperature, with the first coating composition containing Nittobo PAA-HCl-10 L (MW 150K). Excess non-absorbed material was rinsed away by dipping into deionized water. The TPU sheet was then dipped into the second coating composition containing Sun Chemical Sunmica Gold for 300 seconds with excess material again rinsed away in a similar fashion with the first layer. Once the film was air-dry, the PET liner was removed and the visible electromagnetic transmittance (Tvis) of the resulting coated film was measured by a BYK HazeGard Pro. The Tvis was 62.1%. As a comparison, the Tvis from a film coated with pH 9.5 polyallylamine hydrochloride under otherwise the same conditions (Example 1) was 41.4%. The flop index of the resulting film was found to be 26.5 as measured by an X-Rite model MA68II.

### Comparative Example: Tvis of Premixing PAH and Mica

As a comparative example, the two coating compositions that are suitable for forming the first and the second layers of the composite coatings and prepared according to Example 1 were premixed before the actual deposition. Upon mixing, agglomeration happened, and the resulting suspension was gently agitated via a magnetic stir bar. A 6 mil thick, 2″×2″ sheet of thermoplastic polyurethane (TPU) film with one side covered by a 2 mil PET liner was used as substrate.

The substrate was dipped into the suspension for 20 min and excess non-absorbed material was rinsed away by dipping into deionized water. At this point, a very tiny amount of flakes was absorbed on the film surface. Once the film was air-dry, the PET liner was removed and the visible electromagnetic transmittance (Tvis) of the resulting coated film was measured by a BYK HazeGard Pro. The Tvis was 93.1%. The flop index of the resulting film was found to be 0.9 as measured by an X-Rite model MA68II.

### Example 6. Image Analysis of Dip Coating Silver Mica

To produce a coating composition suitable for forming the first layer (binding layer) of the composite coating, 7 g of polyallylamine hydrochloride stock solution (Nittobo PAA-HCl-10 L, MW 150K) was diluted with 2 L of deionized water. The pH of the resulting solution was adjusted to 9.5 with 3M sodium hydroxide solution. To produce a coating composition suitable for forming the second layer of the composite coating, 30 g of mica flakes Sun Chemical Sunmica Silver White (Product Code 2800004, which contains 55-60% mica (RI of about 1.5) coated with 40-44% titanium dioxide (RI of about 2.6), a reported average particle size D50 via laser diffraction, reported as a volume equivalent sphere diameter, of 9 microns, and a thickness of 550 nm (via microscope) were mixed with 1 L of deionized water. The resulting suspension was gently agitated via a magnetic stir bar. A 6 mil thick, 2″×2″ sheet of thermoplastic polyurethane (TPU) film with one side covered by a 2 mil PET liner was used as substrate.

A first layer was formed on the TPU sheet by dip coating for 120 seconds, at ambient pressure and temperature, with the first coating composition containing Nittobo PAA-HCl-10 L (MW 150K). Excess non-absorbed material was rinsed away by dipping into deionized water. The TPU sheet was then dipped into the second coating composition containing Sun Chemical Sunmica Silver White for 300 seconds with excess material again rinsed away in a similar fashion with the first layer. Once the film was air-dry, the PET liner was removed and image analysis was performed. The Flake Area Density was found to be 44.97%, calculated from the image.

### Example 7. Roll-to-Roll Coating Gold Flake-FLOP and Image

To produce a coating composition suitable for forming the first layer (binding layer) of the composite coating, 14 g of the relatively high molecular weight polyallylamine hydrochloride stock solution (Nittobo PAA-HCl-10 L, MW 150K) was diluted with 4 L of deionized water. The pH of the resulting solution was adjusted to 9.5 with 3M sodium hydroxide solution. To produce a coating composition suitable for forming the second layer of the composite coating, 5 g of poly(acrylic acid) partial sodium salt solution (Sigma Aldrich, 25 wt. % in H2O, average Mw˜240K) was diluted with 2 L of deionized water. The pH of the resulting solution was adjusted to 5 with 3M sodium hydroxide solution. To produce another coating composition suitable for forming the second layer of the composite coating, 6 g of choline chloride (no agglomeration) (Sigma Aldrich) was dissolved in 650 mL of deionized water. The pH of the resulting solution was adjusted to 10.5 with 3M choline hydroxide solution. Then, 20 g of mica flake Sun Chemical Sunmica Gold (Product Code 2841117, particle size 5-25 micron) were added to the solution. The resulting suspension was gently agitated via a magnetic stir bar. A sheet of thermoplastic polyurethane (TPU) film (as substrate) with a thickness of 6 mil was pretreated by passing through a conventional corona treatment.

A first layer was formed on the TPU sheet by spray coating, at ambient pressure and temperature, a first coating composition containing Nittobo PAA-HCl-10 L. Excess non-absorbed material was rinsed away with a deionized water spray. The coating composition containing poly(acrylic acid) partial sodium salt was then sprayed onto the surface of the first layer with excess material again rinsed away in a similar fashion as the first layer. This deposition process was repeated 9 times where the second layer contained poly(acrylic acid) partial sodium salt followed by 6 times where the second layer contained Sun Chemical Sunmica Gold, thereby depositing a total of 16 composite coatings on the substrate. The visible electromagnetic transmittance (Tvis) of the resulting coated film was 76.9% as of measured by a BYK HazeGard Pro. The film was then laminated to a black panel for flop index measurement by an X-Rite model MA68II. The flop index of the resulting coated film was 23. When the above process was repeated with Sun Chemical Sunmica Silver White (Product Code 2800004, particle size <15 micron), the resulting coated film had a flop index of 25. (OEM paint is 15-17.)

### Example 8. Roll to-Roll Coating Magenta/Gold/Black-FLOP and Image

To produce a coating composition suitable for forming the first layer (binding layer) of the composite coating, 14 g of polyallylamine hydrochloride stock solution (Nittobo PAA-HCl-10 L, MW 150K) was diluted with 4 L of deionized water. The pH of the resulting solution was adjusted to 9.5 with 3M sodium hydroxide solution. To produce a coating composition suitable for forming the second layer of the composite coating, 100 g of a dispersion of colloidally stable color pigment Cabot Cab-O-Jet 265M magenta was diluted with 2 L of deionized water. 5.84 g of sodium chloride was then added to the resulting solution (50 mM) to screen the electrostatic repulsion of the particles in suspension and prepare them for deposition. To produce another coating composition suitable for forming the second layer of the composite coating, 6 g of choline chloride (Sigma Aldrich) was dissolved in 650 mL of deionized water. The pH of the resulting solution was adjusted to 10.5 with 3M choline hydroxide solution. Then, 20 g of mica flake Sun Chemical Sunmica Gold (Product Code 2841117, particle size 5-25 micron) were added to the solution. The resulting suspension was gently agitated via a magnetic stir bar. To produce a third coating composition suitable for forming the second layer of the composite coating, 200 g of Cabot Cab-O-Jet 200 carbon black dispersion was diluted with 2 L of deionized water. 11.68 g of sodium chloride was then added to the resulting solution (100 mM) to screen the electrostatic repulsion of the particles in suspension and prepare them for deposition.

A sheet of thermoplastic polyurethane (TPU) film (as substrate) with a thickness of 6 mil was pretreated by passing through a conventional corona treatment. A first layer was formed on the TPU sheet by spray coating, at ambient pressure and temperature, a first coating composition containing Nittobo PAA-HCl-10 L. Excess non-absorbed material was rinsed away with a deionized water spray. The coating composition containing Cabot Cab-O-Jet 265M magenta was then sprayed onto the surface of the first layer with excess material again rinsed away in a similar fashion with the first layer. This deposition process was repeated 14 times where the second layer contained Cab-O-Jet 265M magenta followed by 10 times where the second layer contained Sun Chemical Sunmica Gold followed by 20 times where the second layer contained Cab-O-Jet 200 carbon black, thereby depositing a total of 45 composite bilayer coatings on the substrate. The visible electromagnetic transmittance (Tvis) of the resulting coated film was 0.22% as measured by a BYK HazeGard Pro. The flop index of the resulting coated film measured from the magenta side was 34 by an X-Rite model MA68II. The resulting coated film had a Flake Area Density of 13.14% and Flake No. Density of 524 flakes/mm².

A person skilled in the art will recognize that the measurements described herein are measurements based on publicly available standards and guidelines that can be obtained by a variety of different specific test methods. The test methods described represents only one available method to obtain each of the required measurements.

The foregoing description of various embodiments of the invention has been presented for purposes of illustration and description. It is not intended to be exhaustive or to limit the invention to the precise embodiments disclosed. Numerous modifications or variations are possible in electromagnetic energy of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A special effect film, comprising:
a) a polymeric substrate; and
b) a composite coating, the composite coating comprising a first layer comprising a polyionic binder and a second layer comprising interference particles, wherein each of the first layer and the second layer include a binding group component which together form a complementary binding group pair, and
wherein the interference particles comprise at least one highly refractive layer and at least one lower refractive layer, and wherein a difference in refractive index between the at least one highly refractive layer and the at least one lower refractive layer is at least 0.1 units.

2. The special effect film of claim 1, wherein a difference in refractive index between the at least one highly refractive layer and the at least one lower refractive layer is at least 0.3 units, or at least 0.5 units.

3. The special effect film of claim 1, wherein the at least one highly refractive layer is on a surface of the interference particles.

4. The special effect film of claim 1, wherein the special effect film exhibits a flop index of at least 20.

5. The special effect film of claim 1, wherein the interference particles have an average thickness from about 5 nm to about 2000 nm (via microscope) and an average D50 diameter (volume equivalent sphere diameter) from about 1 μm to about 500 μm.

6. The special effect film of claim 1, wherein the interference particles reflect light at wavelengths from 300 nm to 800 nm.

7. The special effect film of claim 1, wherein the composite coating has a total thickness of 250 nm to 5 μm, or 500 nm to 2 μm, or 500 nm to 1 μm.

8. The special effect film of claim 1, wherein the first layer is immediately adjacent to the polymeric substrate at its first face and the second layer is immediately adjacent to the first layer at its opposite face.

9. The special effect film of claim 1, wherein the special effect film further comprises a primer layer between the polymeric substrate and the composite coating.

10. The special effect film of claim 1, wherein the second layer further comprises a pigment particle.

11. The special effect film of claim 1, further comprising a second composite coating, the second composite coating comprises a first layer comprising a polyionic binder and a second layer comprising one or more of a special effect particle or a pigment particle, wherein the first layer of the second composite coating and the second layer of the second composite coating, comprise a complementary binding group pair.

12. The special effect film of claim 1, wherein the second layer of the first composite coating and the second layer of the second composite coating in combination provide an additive effect on the special effect character and effect of the special effect film product.

13. The special effect film of claim 1, further comprising a mounting adhesive layer applied to a surface of the polymeric substrate opposite the composite coating.

14. A vehicle panel having the special effect film of claim 1.

15. A vehicle having the special effect film of claim 1 applied thereto.

16. The special effect film of claim 1, wherein the vehicle is selected from the group consisting of an automobile, aircraft or boat.

17. The special effect film of claim 1, wherein at least one of the first layer and the second layer of the composite coating is formed from an aqueous solution.

18. The special effect film of claim 1, wherein the polymeric substrate comprises one or more of a polyvinyl butyral film, a polyurethane film, a poly(vinyl chloride) film, or a multilayer polymeric film.

19. The special effect film of claim 1, wherein the polymeric substrate comprises a flexible multilayer polymeric composite film, and wherein the flexible multilayer polymeric composite film is a polyurethane-based flexible multilayer composite film.

20. The special effect film of claim 1, wherein the special effect film is a composite for coloring an opaque article by application thereto.

21. The special effect film of claim 1, wherein the special effect film exhibits a flop index of at least 20.

22. The special effect film of claim 1, wherein the special effect film exhibits a flop index of at least 30.

23. The special effect film of claim 1, wherein the special effect film exhibits a flop index from about 20 to about 30.

24. The special effect film of claim 1, wherein the interference particles have an average thickness from 50 nm to 1000 nm (via microscope) and an average D50 diameter (volume equivalent sphere diameter) from about 3 μm to about 250 μm.

25. The special effect film of claim 1, wherein the interference particles have an average thickness from 200 nm to 800 nm (via microscope) and an average D50 diameter (volume equivalent sphere diameter) from about 5 μm to about 50 μm.

26. The special effect film of claim 1, further comprising a mounting adhesive layer applied to a surface of the composite coating opposite the polymeric substrate.

27. The special effect film of claim 1, further comprising an opacifying layer applied to a surface of the composite coating opposite the polymeric substrate.

28. The special effect film of claim 1, further comprising a protective topcoat.
